(19) United States
(12) Patent Application Publication
(10) Pub. No.: US 2006/0089883 A1
(43) Pub. Date: Apr. 27, 2006

(54) Apparatus and method for facilitating and augmenting delivery confirmation

(76) Inventor: James Jeffery Peoples, Cambridge, MA (US)

Correspondence Address: LEE WEINSTEIN, 32A FAIRMONT STREET, ARLINGTON, MA, 02474, US

(21) Appl. No.: 10/973,539

(22) Filed: Oct. 26, 2004

(51) Int. Cl. G01G 19/22

(52) U.S. Cl. 705/26

(57) ABSTRACT

A method and apparatus ins disclosed for minimum-cost mailing utilizing the First Class Delivery Confirmation service of United States Postal Service. In one aspect, the invention provides light-weight packaging which meets USPS delivery confirmation dimensional standards without creasing contents. In another aspect the invention automatically electronically retrieves delivery confirmation data from the USPS, and automatically schedules and initiates electronic communication (such as phone calls, faxes, or e-mails) to customers subsequent to delivery confirmation.

### FIELD OF THE INVENTION

The field of the invention pertains to parcel delivery, direct marketing, and more particularly to the First-Class Delivery Confirmation service of the United States Post Office, and to automated parcel delivery tracking systems.

### BACKGROUND OF THE INVENTION

As various parcel delivery services have competed for business in recent years, delivery confirmation has become available in connection with an increasing variety of delivery services. For many years, the United States Postal Service (USPS) has provided delivery methods which make available to consumers sending mail features such as delivery confirmation (in paper form, provided through the U.S. Mail). Such services include “Return Receipt Requested” services, and Certified Mail.

In recent years, Internet access to delivery confirmation and parcel tracking information has become available through a variety of carriers, including the UPS, Federal Express, and the USPS.

The first delivery services for which the USPS made delivery confirmation available via the internet were Express Mail™ and Priority Mail™, and Certified Mail™. The least expensive parcels which may be sent by these services cost $13.65, $3.85, and $2.65 in postage, respectively.

Recently the USPS has made available electronic delivery confirmation (where mailers may verify delivery via the Internet) on First-Class parcels meeting certain criteria. This new first class delivery confirmation service could in theory represent by far the cheapest alternative for mailers seeking low-priced delivery confirmation, but the packaging criteria outlined below must be met, and methods currently commercially available to meet the criteria tend to increase mailing costs substantially, thus reducing the potential savings. Some of the relevant regulations are described below in detail. In order to make practical electronic delivery confirmation on First-Class parcels, the USPS has equipped all letter carriers with electronic scanners, and the USPS now requires letter carriers to scan all parcels which meet the requirements for First Class Delivery Confirmation at the time of delivery. Because the majority of First-Class mail is not scanned, some of the features set forth by the USPS for a First-Class parcel to be eligible for delivery confirmation are features designed to make these parcels easily visibly differentiable from other mail by letter carriers, so the letter carriers will notice the parcels and scan them at time of delivery.

The USPS regulations covering First-Class and standard mail delivery confirmation (DMM 57, S918) authorize the use of Delivery Confirmation for First-Class parcels as defined in DMM 57 C100.5.0 as shown below. It is anticipated that authorization for delivery confirmation will be expanded in the future to other classes of mail. Regulation DMM 57 C100.5.0 states:
5.0 Parcels

For the purposes of adding Delivery Confirmation or Signature Confirmation, a First-Class Mail parcel is defined as any piece that:

a. Has an address side with enough surface area to fit the delivery address, return address, postage, markings and endorsements, and special service label; and,

b. Is in a box or, if not in a box, is more than ¾-inch thick at its thickest point

DMM 57, C050.4 further specifies:
4.0 Machinable Parcel
4.1 Criteria

A machinable parcel is any piece that is:

a. Not less than 6 inches long, 3 inches high, ¼ inch thick, and 6 ounces in weight. (A mail piece exactly ¼ inch thick is subject to the 3½-inch height minimum under C010<C010.htm>.)

b. Not more than 34 inches long, or 17 inches high, or 17 inches thick, or 35 pounds in weight. For books or other printed matter, the maximum weight is 25 pounds.

DMM 57, C010.3.1a goes on to define the materials that qualify a box stating:
3.1 Boxes

Boxes are acceptable, subject to these standards:

a. Paperboard boxes may be used for easy and average loads to 10 pounds.

b. Metal-stayed paperboard boxes may be used for easy and average loads to 20 pounds.

USPS regulations further specify that in order to qualify for First-Class delivery confirmation, a parcel must have a mailing label (or markings equivalent to such label) including certain machine-readable features (including a barcode).

Although it is not part of the regulations, the retail First-Class delivery confirmation labels sold by the USPS are printed in a readily identifiable fluorescent green color, designed to visually differentiate First-Class delivery confirmation parcels so that letter carriers will have a high probability of spotting them and scanning them as required.

Some companies supplying mailing materials have begun offering for sale mailing labels meeting the labeling requirements for First-Class delivery confirmation, and in conjunction with these labels, these companies sell ¾″ thick foam cubes to be placed inside envelopes intended for First-Class delivery confirmation, in order to insure that the parcel mailed will meet the requirement for being at least ¾″ thick at it's thickest point. There are several drawbacks to the use of these cubes. First, the cubes must be placed in the parcels by hand, because automated envelope-stuffing equipment usually won't handle them. Second, once the parcels have the cubes stuffed in them, the parcels don't stack well, so handling large quantities of such parcels becomes significantly more cumbersome for mailers. Third, the cubes may have a tendency to dent or crease the sheets of paper within the parcel. Fourth, because the cube is placed within the parcel, it can cause confusion for the recipient, who may wonder what the purpose of the cube is (when in fact the cube was just placed inside the parcel to cause the dimensions of the parcel to meet delivery confirmation requirements of the USPS).

### OBJECTS OF THE INVENTION

It is an object of the present invention to provide a means of augmenting readily available mailing envelopes to meet First-Class delivery confirmation parcel dimension requirements, while maintaining for mailers good stackability of parcels. It is a further object of the present invention to provide a means of augmenting readily available mailing envelopes to meet First-Class delivery confirmation parcel dimension requirements, while aiding mailers in maintaining the un-creased integrity of mailed sheet materials. It is a further object of the present invention to provide a means of augmenting readily available mailing envelopes to meet First-Class delivery confirmation parcel dimension requirements in such a way that traditional automated envelope stuffing and sealing machinery may still be used. It is a further object of the present invention to increase the percentage of First-Class delivery confirmation parcels which are scanned as intended, by providing visual features which are more readily noticed and differentiated by letter carriers. It is a further object of the present invention to advance the state of the art in automated features available to mailers and mail recipients in conjunction with the delivery of parcels on which electronic delivery confirmation is available.

### SUMMARY OF THE INVENTION

In one preferred embodiment, the present invention provides a means and a method for externally modifying parcel to meet the ¾″ minimum thickness requirements of the USPS for First-Class delivery confirmation, while simultaneously maintaining good stackability of such parcels, and providing improved visual differentiability for mail carriers. Two “thick return address label” preferred embodiments of the present invention are shown in FIGS. 1 and 2. In each of these embodiments a “thick” return address label is applied to a regular envelope to provide the minimal thickness of ¾″ required by USPS regulations for First-Class delivery confirmation. In both FIG. 1 and FIG. 2, the thick labels have beveled sides to minimize the chance they would be torn off by getting caught on other mail.

FIG. 3 depicts a “thick address label” preferred embodiment of the present invention. The “thick return address label” embodiments of FIGS. 1 and 2 offer better stacking properties than the “thick address label” embodiment shown in FIG. 3, because each set of four envelopes may be stacked such that their thick return address labels are in four different corners of the stack.

In another preferred embodiment, the present invention provides a means to meet first class delivery confirmation requirements by providing a very light-weight, bubble-lined envelope, where the thickness of the bubble-lining of the envelope is sufficient to insure that the entire package will be at least three quarters of an inch thick.

Envelopes made according to the present invention allow mailers to meet delivery-confirmation dimensional and label requirements of the USPS with an extremely light-weight package, thus allowing mailers to receive delivery confirmation on parcels mailed with only 62 cents postage, while reducing chances of creasing or damage to contents during processing and shipping.

In another aspect, the present invention offers software features providing added value to mailers and mail recipients, including automated generation of delivery confirmation e-mail to mailers, automatic scheduling and/or delivery of follow-up e-mail and/or fax and/or phone calls to recipients following delivery confirmation, and automatic scheduling of appointments or visits following delivery confirmation.

### BRIEF DESCRIPTION OF THE DRAWINGS

FIG. 1 depicts a “single-sided” thick return address label embodiment of the present invention.

FIG. 2 depicts a “double-sided” thick return address label embodiment of the present invention.

FIG. 3 depicts a “thick mailing label” embodiment of the present invention.

FIG. 4 depicts automated delivery of goods and services based on automated periodic retrieval of delivery confirmation information.

FIG. 5 depicts a “thick bubble envelope” embodiment of the present invention.

### DETAILED DESCRIPTION OF SOME PREFERRED EMBODIMENTS

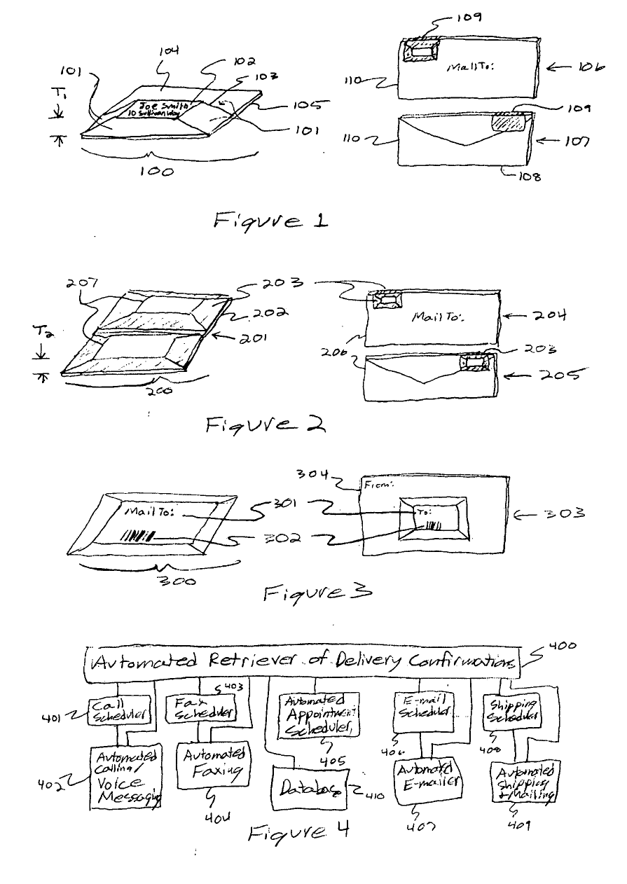

A “thick return address label” preferred embodiment of the present invention is depicted in FIG. 1. Thick return address label 100 comprises truncated pyramidal structure 103, fold-over paper 104, and adhesive backing 105. Truncated pyramidal structure 103 having thickness T1 affixes to envelope 110 through adhesive backing 105 and fold-over paper 104. Beveled edges 101 and fold-over paper 104 are colored fluorescent green to aid in visual differentiation delivery-confirmation mail. Fold-over over paper 104 folds over the edge of envelope 110, providing visual coloring on the front, back, and top edge 109 of envelope 110, as seen in front envelope view 106 and back envelope view 107.

In an alternate preferred embodiment, fold-over paper 104 may continue far enough to wrap back up around bottom edge 108 of envelope 110, further improving visual differentiability. Top surface 102 of truncated pyramidal structure 103 displays return address information.

Truncated pyramidal structure 103 preferentially comprises a low-mass structure, such as a hollow plastic shell, or foam-core paper of plastic.

An alternate “thick return address label” embodiment of the present invention is depicted in FIG. 2. Thick return address label 200 comprises truncated pyramidal structures 207, fold-over paper 201, and adhesive backing 202. In this embodiment, two truncated pyramidal structures 207 (each having reduced thickness T2) form a fold around envelope 206 like a clam shell, and is shown affixed to envelope 206 in front view 204 and back view 205. Beveled edges 203 and fold-over paper 202 are preferentially colored fluorescent green (indicated as coloring 203) to aid in visual differentiation delivery-confirmation mail. Thickness T2 in FIG. 2 may be half of thickness T1 in FIG. 1.

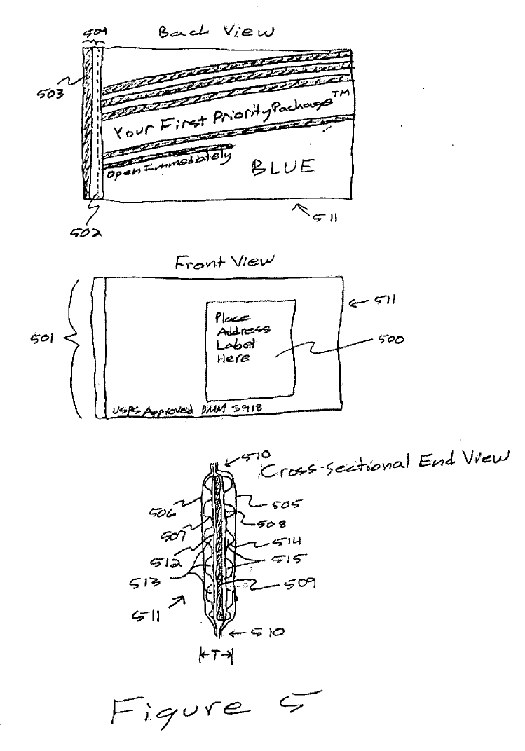

FIG. 3 depicts a “thick address label” embodiment of the present invention 300 with mailing address 301 and barcode 302 printed on the face, shown mounted to envelope 304 in front view 303.

FIG. 5 depicts a “thick bubble envelope” embodiment of the present invention. On the front side of bubble envelope 511, graphic 500 shows where to attach a USPS-approved first class delivery confirmation mailing label. The back side of closure flap 504 is equipped with adhesive strip 503. Perforation 502 facilitates easy opening of envelope 511.

Envelope 511 consists of six layers of material sandwiched together, forming an enclosed space for insertion of contents 509. The outermost back layer 506 of envelope 511 and the outermost front layer 505 of envelope 511 may consist of either paper or plastic. The back inner bubble liner is comprised of flat plastic layer 512 and bubbled plastic layer 507, bonded together to create a back matrix of sealed-air bubbles 513. The front inner bubble liner is comprised of flat plastic layer 508 and bubbled plastic layer 514, bonded together to create a front matrix of sealed-air bubbles 515.

The front and back layers and the front and back bubble matrix composite layers are all bonded together as a sandwich around all edges of envelope 511 except insertion end 501. Innermost plastic layers 508 and 512 are smooth, to facilitate use of envelope 511 in auto-insertion equipment, such that contents 509 do not catch on any bubble edges when being inserted. The thickness T of envelope 511 is at least 0.75 inches, thus meeting the thickness requirement for USPS first class delivery confirmation.

FIG. 4 depicts automated apparatus used in the automated delivery of goods and services based on delivery confirmation information. Automated retriever 400 periodically retrieves delivery confirmation information via the Internet. Call scheduler 401 automatically schedules calls to parcel recipients or related persons based on information in database 410. Calls made by automated calling engine 402 may connect two live parties, or may leave voice mail messages. Fax scheduler 403 automatically schedules faxes to parcel recipients or related persons based on information in database 410, via fax delivery engine 404. Fax delivery may be scheduled to happen as soon as possible, or at a specified time.

Automated appointment scheduler 405 schedules in-person or phone appointments with customers based on information in database 410. E-mails are sent immediately by automatic e-mail engine 407, or scheduled for later delivery by e-mail scheduler 406, based on information in database 410. Automated shipments may be sent immediately by Automated shipping and mailing apparatus 409 in response to delivery confirmation information and information is database 410, or shipments may be scheduled to happen at a future time by automated shipment scheduler 408.

In a low-cost preferred embodiment of the present invention for use in small businesses, all automated delivery confirmation retrieval, automated fax sending, automated e-mail sending, and automated initiation of voice calls described above are accomplished by a single personal computer equipped with a modem card and an internet connection, and containing database 410.

In a larger-scale preferred embodiment of the present invention the means for scheduling and placing outbound calls and faxes may comprise multi-line networked call center equipment commonly used for telemarketing, etc.

Other forms of automated electronic communication to parcel recipients (besides e-mail, fax, or phone call) are also contemplated and within the scope of the present invention. These other forms of automated electronic communication may include instant messaging (IM), paging, wireless communications, telegrams, etc.

The foregoing detailed description has been given for clearness of understanding only, and no unnecessary limitation should be understood therefrom, as modifications will be obvious to those skilled in the art.

What is claimed is:

1. An first-class delivery confirmation package comprising:
a bubble envelope with a total thickness of at least 0.75 inches.

2. An first-class delivery confirmation package comprising:
an outer envelope;
an inner envelope within said outer envelope;
padding material held captive between said inner and outer envelopes;
said inner envelope and said outer envelope being bonded together along at lease a portion of their peripheries; and
the total thickness of said inner and outer envelopes and said padding being greater than or equal to 0.75 inches.

3. A first-class delivery confirmation label comprising:
a back planar adhesive surface;
a front planar surface parallel to said back surface, said front surface having an area less than said back surface;
beveled edges joining said front and back surfaces;
said front and back surfaces being separated by at least 0.1 inches.

4. A delivery-confirmation-triggered contact system comprising:
means for automatically electronically retrieving from the United States Postal Service delivery confirmation information confirming delivery of a parcel mailed to a recipient; and
means for automatically initiating electronic communication to said recipient subsequent to obtaining said delivery confirmation information.

5. A method for automated customer contact subsequent to delivery confirmation, comprising:
periodically electronically querying the United Sates Postal Service for confirmation of delivery of a parcel to a recipient; and
Automatically initiating an electronic communication to said recipient subsequent to electronically receiving confirmation of said parcel to said recipient.
